(19) United States
(12) Patent Application Publication
(10) Pub. No.: US 2021/0158498 A1
(43) Pub. Date: May 27, 2021

(54) WAFER INSPECTION METHODS AND DEVICES

(71) Applicant: Carl Zeiss SMT GmbH, Oberkochen (DE)

(72) Inventor: Jagdish Chandra Saraswatula, Singapore (SG)

(21) Appl. No.: 16/692,047

(22) Filed: Nov. 22, 2019

(51) Int. Cl. G06T 7/00

(52) U.S. Cl. CPC G06T 7/001; G06T 2207/30148; G06T 2207/10148; G06T 2207/20081; G06T 2207/10152; G06T 2207/10061

(57) ABSTRACT

A method for providing a trained defect candidate detection algorithm includes: acquiring an optical image of a processed wafer; receiving a multi-beam scanning electron microscope (MSEM) image; covering a portion of the processed wafer corresponding to a portion of the optical image; and training a defect candidate detection algorithm based on the optical image and a result of an analysis of the MSEM image with regard to defect candidates. A wafer inspection method and an optical inspector using the trained defect candidate detection algorithm are disclosed.

### FIELD

The present application relates to wafer inspection methods and devices.

### BACKGROUND

In order to obtain a high yield of semiconductor devices of close to 100%, it is generally desirable to closely monitor variations in any fabrication step that may indicate process variations leading to defects. In modern manufacturing lines, up to 200 wafers may pass each fabrication step per hour. Therefore, high speed in-line metrology is commonly used between different fabrication steps or is integrated into the fabrication steps. This metrology is sometimes also called wafer inspection. Wafer inspection tools are typically used to detect indications of process variations or defect candidates within a structure after specified fabrication steps. Typical silicon wafers used in manufacturing of semiconductor devices have diameters of up to 12 inches (300 mm). Optical inspection of the whole wafer may be performed in a reasonable amount of time.

Current state-of-the-art semiconductor devices are often built with minimum structure sizes or Critical Dimensions (CD) of down to about 5 nanometers, and devices with smaller critical dimensions are being developed. The fabrication of such semiconductor devices, depending on the type of device, may involve about 1000 fabrication steps, starting with a blanc wafer, to form the semiconductor devices on the wafers. These fabrication steps can include for example about 100 lithography steps.

The higher number of lithography steps can increase the noise for optical inspection. In particular, the result of an optical inspection of a given layer may be influenced by noise generated by a prior layer, by phase changes such as local and global dimension changes in the z direction, by line edge roughness (LER), which when combined with phase based detection apertures can lead to further noise, and by core resolution limitations of optics.

Optical inspection may identify defect candidates and/or regions of defect candidates. Due to the small structure sizes mentioned above, defect candidates and/or regions of defect candidates may have to be analyzed further with techniques like single beam scanning electron microscopy (SEM) or x-ray diffraction to verify the presence of a physical defect and, possibly, the nature thereof.

Typically, SEM and/or x-ray diffraction analysis of the defect candidates and/or regions of defect candidates involves a substantial amount of time. Thus, suitable defect candidates and/or regions of defect candidates are desirably identified with high reliability.

### SUMMARY

In an aspect, the present application provides a method for providing a trained defect candidate detection algorithm. The method includes acquiring an optical image of a processed wafer, and receiving a multi-beam scanning electron microscope (MSEM) image. The method also includes covering a portion of the processed wafer corresponding to a portion of the optical image, and training a defect candidate detection algorithm based on the optical image and a result of an analysis of the MSEM image with regard to defect candidates.

In an aspect, the present application provides an optical inspector that includes an optical camera for acquiring an optical image of a processed wafer and an evaluation device configured for applying a trained defect candidate detection algorithm on the optical image of the processed wafer to identify one or more defect candidates. The defect candidate detection algorithm has been trained according to a method described in the preceding paragraph.

A method for providing a trained defect candidate detection algorithm includes acquiring an optical image of a processed wafer, receiving a MSEM image, covering a portion of the processed wafer corresponding to a portion of the optical image, and training a defect candidate detection algorithm based on the optical image and a result of an analysis of the MSEM image with regard to defect candidates.

The combination of optical imaging and multi-beam scanning electron microscopy may allow for scanning large areas for defect candidates while avoiding detecting to many “false” defect candidates. Reducing the number of such “false positives” may render verifying processed wafers more economical. A processed wafer as used herein, may refer to a partially processed or fully processed wafer, or, in other words, a wafer in any stage during or after the front-end processing of the wafer. The MSEM image may allow for identifying defect candidates which are not immediately apparent in the optical image. For example, defect candidates may be hidden by in a noisy optical image. Based on the trained defect candidate detection algorithm it may be possible to detect defect candidates in the optical image even with low signal to noise ratios.

An embodiment of the method, training the defect candidate detection algorithm includes identifying a possible defect candidate based on the optical image and verifying if the possible defect candidate is a defect candidate based on the MSEM image. An untrained defect candidate detections algorithm may identify a huge number of possible defect candidates, which may also be called events. For example, the number may exceed twelve million. These possible defect candidates include false positives. Only some events, e.g. 20.000 events, may relate defect candidates which should be further analyzed. The MSEM image may be used to identify “true” defect candidates and sort out false positives among the possible defect candidates. The result of the MSEM analysis may than be used to train the defect candidate detection algorithm to reduce the number of false positives derived from the analysis of the optical image.

In an embodiment, training the defect candidate detection algorithm includes detecting noise within the optical image. Detecting noise within the optical image may allow for noise filtering the optical image for obtaining a filter optical image which may facilitate detecting “true” defect candidates for further analysis. Detecting noise and/or obtaining information on the noise characteristics may be particularly useful, because more than 98 percent of the events detected on a processed or production wafer by optical inspection may relate to noise. Using a machine learning algorithm to detect and characterize these noise may be very useful to filter out the noise. Multiple iterations of obtaining an optical image, obtaining an MSEM image and training the candidate detection algorithm with a machine learning algorithm may be used to improve the candidate detection algorithm.

According to another embodiment, the portion of the processed wafer corresponds to an area of the processed wafer including a higher density of defect candidates than other areas of the processed wafer. Analyzing areas with a higher density of defect candidates makes it easier to find the physical origin of a certain defect. For example, analyzing defect candidates may include cutting an analyzing sample from the processed wafer and preparing the analyzing sample. Selecting areas with a higher of defect candidates may result in an analyzing sample including several defect candidates which may be analyzed without having to prepare an additional analyzing sample. The approach may save considerable time.

Further, an embodiment of the method prescribes that the portion corresponds to a die to be cut from the processed wafer.

In an additional embodiment, training includes changing at least one parameter for acquiring the optical image. Changing at least one parameter for acquiring the optical image may allow for optimizing the optical image before identifying features in the optical image. This may allow detecting defect candidates with a higher reliability.

According to an embodiment, the parameter is one of an illumination wavelength, an illumination polarity, illumination intensity, an image capturing time, an image capturing focus, an image capturing focus.

Further, an embodiment prescribes that the method further includes acquiring a single-beam scanning electron microscope image, SEM image, of the defect candidate; analyzing the defect candidate based on the SEM image to obtain a defect; training the defect candidate detection algorithm with the optical image and the defect. A single-beam scanning electron microscope image may allow for a deeper analysis of defect candidate and training the candidate defect algorithm with the optical image and the defect identified via the single-beam scanning electron microscope may improve the probability that a defect candidate actually relates to a defect.

Moreover, it is suggested an optical inspector including an optical camera for acquiring an optical image of a processed wafer, and an evaluation device configured for applying a trained defect candidate detection algorithm on the optical image of the processed wafer to identify one or more defect candidates, wherein the defect candidate detection algorithm has been trained according to one of the above-identified methods. The optical camera may include a sensor and/or

In an embodiment, the optical inspector includes a light source for illuminating the processed wafer. The light source may be operable for illuminating the processed wafer with visible or infrared light. Moreover, the light source may be operable for illuminating the processed wafer with light having a well-defined polarization. For example, the light source may provide circular polarized or linear polarized light.

In addition, it is proposed a method for inspecting a processed wafer including applying a trained defect candidate detection algorithm on an optical image of the processed wafer to identify one or more defect candidates, wherein the trained defect candidate algorithm has been obtained with a method described above.

An embodiment of the method prescribes acquiring a multi-beam scanning electron microscope image, MSEM image, of a portion of the processed wafer corresponding to a portion of the optical image including the one or more defect candidates, and applying a trained defect detection and classification algorithm on the MSEM image to identify one or more defects.

According to an embodiment, the method further includes analyzing the one or more defects.

Further, an embodiment of the method prescribes that applying the trained defect detection and classification algorithm on the MSEM image includes classifying the defect.

Moreover, it is proposed a computer program including instructions which, when the program is executed by a computer cause the computer to carry out any one of the methods identified above.

### BRIEF DESCRIPTION OF THE DRAWINGS

FIG. 1 is a chart illustrating an application environment for some embodiments.

FIG. 2 is a flowchart illustrating a method for wafer inspection.

FIG. 3 is a block diagram illustrating a device for wafer inspection.

FIGS. 4A to 4Care diagrams illustrating a conversion to a polygon chain.

FIG. 5 is a diagram for further illustrating operations.

FIGS. 6A and 6B show variations of the method of FIG. 2.

FIG. 7 shows an optical image of a processed wafer.

FIG. 8 illustrates a method for training an algorithm for detecting probable defect candidates.

FIG. 9 illustrates a method for training a defect candidate detection algorithm.

### DETAILED DESCRIPTION

In the following, various embodiments will be described in detail referring to the attached drawings. These embodiments are to be understood as examples only and are not to be construed as limiting in any way.

Features from different embodiments may be combined to form further embodiments. Variations or modifications described with respect to one of the embodiments may also be applicable to other embodiments and will therefore not be described repeatedly.

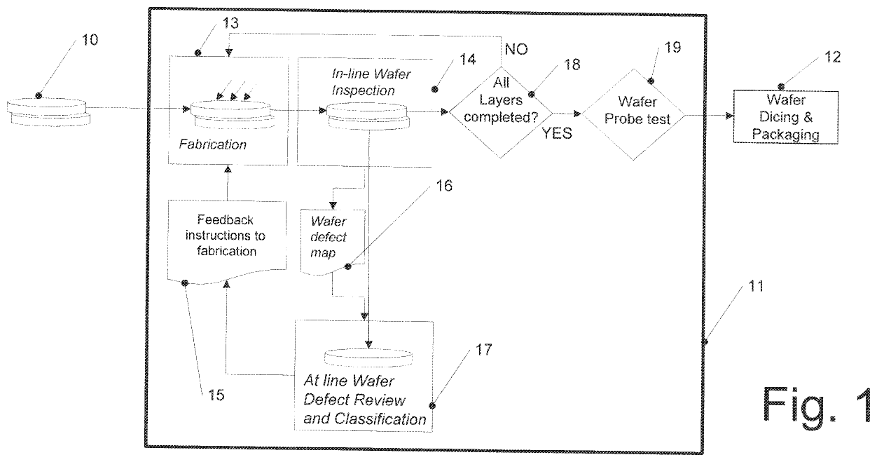

Embodiments as discussed herein may be employed for in-line metrology wafer inspection during manufacturing of semiconductor devices. An example for such a manufacturing of semiconductor devices as an application environment for various embodiments is illustrated in FIG. 1.

In FIG. 1, the manufacturing of semiconductor devices starts with blanc wafers 10. Examples for such blanc wafers 10 include silicon wafers or gallium arsenide wafers, but any semiconductor wafers or other substrates used for semiconductor device manufacturing may be used. First, the wafers 10 are subjected to a so-called front-end processing at 11. Front-end processing relates to all processing steps where structures are formed on or in the wafer, before the structures on the wafers are mechanically separated from each other. For mass production of a plurality of equal structures is formed on the wafers, which are then separated into separate semiconductor devices. Wafers 10 in front-end processing 11 are subjected to a plurality of fabrication steps 13. Such fabrication steps may include etching, layer deposition of semiconductor layers or metal layers, diffusion or implantation, for example for doping, cleaning, wafer planarization, resist coating and resist treatment, lithography exposure etc. With these fabrication steps, structures are formed on wafers 10.

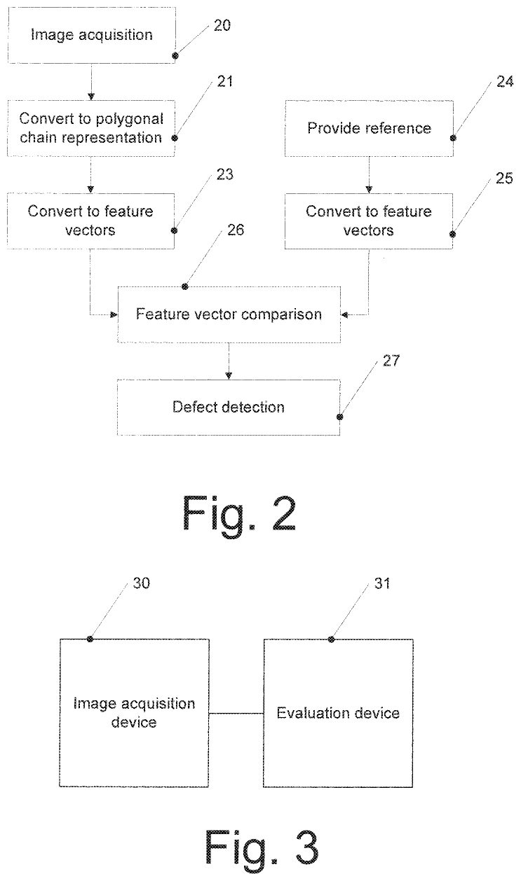

After certain fabrication steps, the wafers are subjected to in-line wafer inspection at 14. In the in-line wafer inspection, methods and devices as explained further below with reference to FIGS. 2 to 6 are used to obtain information where on the wafer structures have not been formed as desired. Generally, such a wafer inspection may include various measurements of physical parameters such as film thickness, film uniformity, detection of foreign particles or contaminations or measuring electrical parameters, like resistance or capacitance. As discussed further below, in particular features and dimensions of structures formed on the wafer are evaluated by acquiring an optical image of the wafer. These measurements may be performed directly on product wafers, i.e. on wafers used to manufacture semiconductor devices for sale, either directly or using specific test structure, or alternatively on specific non-functional monitor wafers (also referred to as dummy wafers). Specifically designed test structures are also known as process control monitors (PCMs). In addition to these measurements, some measurements are actually performed “in situ”, i.e. during a fabrication step.

If defect candidates are detected, the wafer may be provided to an at-line wafer defect review and classification at 17. A defect candidate map or wafer defect map may be generated. “At-line” indicates that the wafers in this case are taken out of the usual production process for further inspection. In particular, in the review at 17, the locations identified in wafer defect map may be reviewed in order to verify and classify the indications of process variations or defects. The determination of the presence or absence of defect candidates at 17 may be carried out by comparing the optical image data to data previously gathered for a similar section of another object (die-to-die), or it may be carried out by comparison to a corresponding portion of a reference database (die-to-database) or a design data (die-to-CAD). All data may be handled and controlled in databases, including defect databases forming a collection of representative defects, CAD databases collecting information about ideal or representative structures, and process recipes. As a result, at 15 feedback instructions to the fabrication may be given, for example to modify fabrication parameters to counter process variations, or also instructions for example to do maintenance due to possible malfunctioning components in a corresponding fabrication device.

These steps are repeated until at 18 all layers of the front-end processing are completed. Following this, at 19 wafer probe testing may be performed, where for example structures on the wafer are contacted electrically by probes to perform test measurements. This concludes the front-end processing.

After the front-end processing at 11, back-end processing 12 follows where the wafers are diced into separate chips, and the chips are packaged. More testing of the semiconductor devices manufactured may occur during the back-end processing 12.

As already discussed in the introductory portion, for large semiconductor wafers and small structure sizes in the in-line wafer inspection at 14, huge amount of data have to be gathered and analyzed. Methods discussed in the following with reference to FIGS. 2 to 5 may help to implement the in-line wafer inspection at 14.

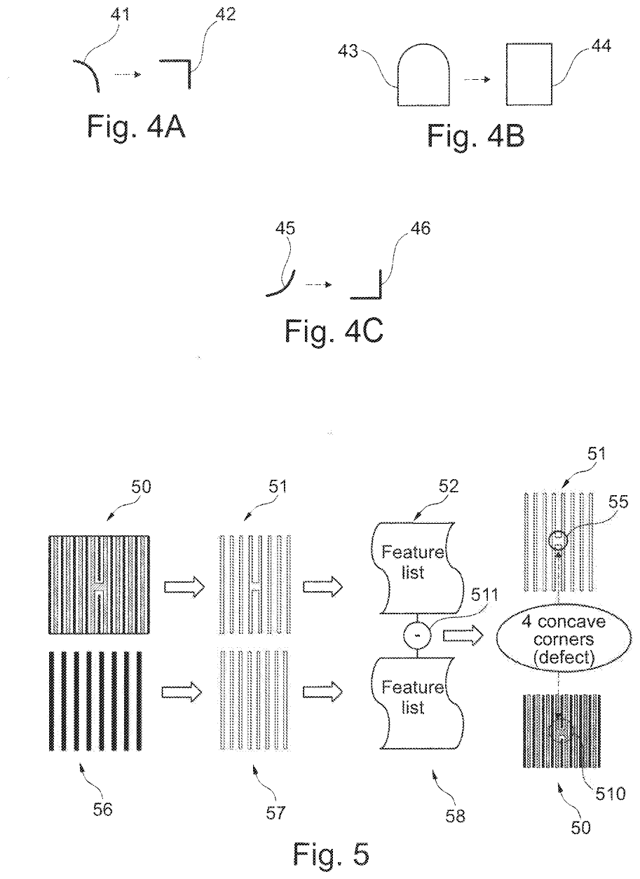

FIG. 2 is a flowchart illustrating an exemplary method for identifying possible defect candidates, and FIG. 3 shows a corresponding device, where the method may be implemented. FIGS. 4A to 4C and 5 show diagrams which will be further used for explaining the method of FIG. 2 and the device of FIG. 3. The method for identifying possible defect candidates may be used as part of a method for training a defect candidate detection algorithm.

At 20, the method includes performing an optical image acquisition of a wafer to be inspected. To this end, the device of FIG. 3 includes an optical image acquisition device. The optical image acquisition device may also be called optical inspector. The term “image”, as used herein, is to be construed broadly and encompasses all data which may represent structures formed on the wafers in an array of image elements. The kind of imaging needed may also depend on the size of the structures on the wafer, as for smaller structures higher resolution techniques are needed. In particular, image acquisition devices 30 may be an optic image acquisition device using light of a short wave length.

An example for an acquired optical image is shown in FIG. 5 bearing reference numeral 50. Here, line structures have been formed on a wafer. In the middle of optical image 50, a deviation from the line structure is visible.

This optical image is then processed further using the method of FIG. 2. To achieve this, in the device of FIG. 3, an evaluation device 31 is provided. Evaluation device 31 may be a computer or similar device having a processor programmed accordingly, for example a desktop computer, a laptop, a tablet PC or the like. Parts or all of the method may be implemented using specific hardware like application specific integrated circuits (ASICs) or field programmable gate arrays (FPGAs). Basically, any device capable of performing the processing discussed in the following may be used.

At 21, the optical image acquired at 20 is processed to be converted to a polygonal chain representation. A polygonal chain is a connected series of line segments. It should be noted that in the context of the present application, such a polygonal chain may also include only a single line segment. In some case, the polygonal chain is closed, such that the last line segment of the series is connected to the first line segment. In this case, a polygon is formed. Sometimes, only closed polygonal chains, i.e. polygons are used. For example, when designing semiconductor chip layouts, in many tools used for design only polygons are used. In such cases, what seem to be lines in a design may for example be formed by thin elongate rectangles. To match such designs, also at 21 and subsequent steps polygons may be used. However, also open polygonal chains may be used. For conversion to polygonal chains, the optical image acquired at 20 may be subjected to a series of image processing steps. In other words, shapes present in the optical image are processed to resemble actual polygonal chains, as they are present in a design as will be explained later.

As a first step, the optical image may be subjected to a thresholding for black and white conversion to separate the foreground which is then converted to polygonal chains from the background. For example, in optical image 50 of FIG. 5, the threshold may be set to remove the background.

For example, the optical image may be provided as a greyscale image. In thresholding, the gray scale image is converted to a binary image by pixel thresholding and thereby a data reduction is achieved. After selection of a threshold value, all pixels having a gray level value which is below the selected threshold value is set to zero (0, black, e.g. background) and all the pixels having a gray level value which is equal to or greater than the threshold value are classified as one (1, white, e.g. foreground). Further details of thresholding may be found at https://www.geeksforgeeks.org/matlab-converting-a-grayscale-image-to-binary-image-using-thresholding/Then, image processing techniques like contour extraction, corner detection and extension (for example to form closed polygonal chains) may be performed. Generally, various feature extraction techniques may be used, in particular polygon feature extraction techniques. An overview over feature extraction techniques may be found on the English Wikipedia page “feature extraction”, retrieved 15:18, May 16, 2019, from https://en.wikipedia.org/w/index.php?title=Feature extraction&oldid=877129337.

Examples for contour extraction may be found in Image Contour Extraction Method based on Computer Technology from Li Huanliang, 4th National Conference on Electrical, Electronics and Computer Engineering (NCEECE 2015), 1185-1189 (2016).

In this way, Manhattan polygonal chains become visible. The term “Manhattan polygonal chains” refers to polygonal chains which have only right angles. They are also referred to as rectilinear polygonal chains.

Several examples for the conversion into a polygonal chain representation, in particular a Manhattan polygonal chain representation, are shown in FIGS. 4A to 4C. In FIG. 4A, an upper round corner 41 is converted to a rectangular polygonal chain 42. In FIG. 4B, a closed shape 43 with a rounded upper part is converted to a rectangular shape 44. In FIG. 4C, a lower round corner 45 is converted to a corresponding rectangular polygonal chain 46.

For the conversion, contours extracted from the optical image may be converted to the closest Manhattan polygon structure. In some cases, this may be achieved using image processing algorithms like contour approximation or convex hull extraction. Contour extraction approximates a contour shape to another shape with less number of vertices depending upon a specified precision. In convex hull extraction, the polygon chains are checked for convexity defects and convex forms are removed. As a result, reduced polygon chains of convex shape are extracted.

For the example of optical image 50, the result of the conversion to a polygonal chain representation is shown at 51 in FIG. 5. Here, the vertical structures now show as vertical lines, and the deviation from the line structure in the middle of the optical image is converted to a rectangular polygon.

It should be noted that in may be still an image, which, however, has been processed to exhibit substantially only polygonal chain features.

Turning to FIG. 2, at 23 the method includes converting the polygonal chain representation thus obtained to a feature vector list. This means that the polygonal chains are now described in terms of their features (for example corners, lines, line ends), in particular as vectors. In other words, the optical image is converted into a list of features represented by vectors. The feature vectors may be extracted using feature extraction techniques like pixel tracing. Further examples for suitable techniques may be found in Dilip Kumar Prasad, “GEOMETRIC PRIMITIVE FEATURE EXTRACTION—CONCEPTS, ALGORITHMS, AND APPLICATIONS”, thesis submitted to Nanyang technological university, School of Computer Engineering, 2012.

This conversion to a feature list is illustrated in FIG. 5 by a feature list 52. This feature list may include convex corners, concave corners, edges and line ends, and may be limited to these elements. Each of these features may have various orientations. For the example of FIG. 5, the feature list 52 contains 16 line ends (2 for each of the 8 vertical lines), 8 vertical line edges, two horizontal lines (having two line ends and 1 line edge each) and 4 concave corners. The feature vector list may be done by using a (co-ordinate{x,y}, feature vector) implementation. E.g at a given coordinate , for example(25, 3700) we have a feature, for example a line-end which we denote as LE. Thus this entire information could be represented as {25, 3700; LE}.

As can be easily seen, by conversion to this list the amount of data may be reduced significantly compared to full image data.

Furthermore, at 24 in FIG. 2 a reference for the wafer is provided. This reference may include design data, i.e. data representing how the wafer was designed to look like in each processing stage. This may be in the form of a computer-aided design (CAD) file, for example a file in the GDSII (graphical design station/graphic data system II) format or OASIS (open artwork system interchange standard) format. This design data already uses Manhattan shapes, i.e. rectilinear polygonal chains. At 25, this reference, e.g. design data, is converted to a feature vector list corresponding to the feature vector list resulting at 23, i.e. feature vectors for the field of view of the optical image acquisition at 20. To achieve this, an alignment and a registration may also be performed when generating the feature vector list at 25 to ensure a corresponding orientation (up and down, left and right) and corresponding field of view between the design data and the polygonal chain representation. It should be noted that steps 24 and 25 may have to be performed only once for each wafer design and each processing stage where the wafer inspection (14 in FIG. 1) is to be performed, i.e. the feature list generated at 25 may be used for inspection of a plurality of wafers of the same design. Instead of design data a fault-free wafer or chip may also be used as a reference. Here, generating the feature list at 25 may be done similar to steps 20-23, i.e. by acquiring an optical image of the reference wafer or chip, performing a conversion to a polygonal chain representation and generating the feature vector list based on this polygonal chain representation.

An example reference wafer or chip is designated with reference numeral 56 in FIG. 5, which, as shown as 57, is converted to a polygonal chain representation which is converted to a feature list at 58. In case design data is used as a reference, this design data may already be in the form of a polygonal chain representation at 57, which is converted to a feature list at 58. In the example of FIG. 5, feature list 58 contains 16 line ends (2 for each of the 8 vertical lines) and 8 vertical line edges.

At 26 in FIG. 2, the method then includes a feature vector comparison between the feature vector list generated at 23 and the feature vectors generated at 25. As the feature vectors are provided as lists, to find differences between the lists, an easy comparison may be implemented. The differences between the lists indicate feature in the wafers that are either additional to or less than the features present in the design provided at 24.

If the feature lists are provided using a (co-ordinate{x,y}, feature vector) implementation as discussed above, the feature vector lists generated from the design and the wafer optical image are aligned. Thus the comparison now becomes even easier and also may give the accurate location of the possible defect candidates to nm precision.

For example, by the comparison symbolized by a minus at 511 in FIG. 5, the rectangular shape 55 in the polygonal representation 51 is identified as a possible defect candidate. In particular, comparing the example feature lists 52 and 58 as explained above, four concave corners and two horizontal lines (with two line ends and one line edge each), which describes the defect.

At 27 in FIG. 2, the possible defect candidates are then detected based on the result of the comparison, for example by checking the detected differences against the optical image acquired at 20. In this case, for example in the optical image 50 reproduced again the area marked with reference numeral 510 is identified as a possible defect candidate. While in the simple example of FIG. 5 obviously the possible defect candidate is easily derivable as a relatively small image with simple structures as shown, the method discussed may also be applied to large area images of wafers with a great plurality of different features and may allow efficient detection of possible defect candidates.

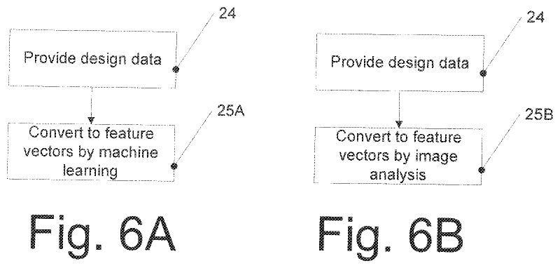

Obtaining feature vectors at 25 from the design data provided at 24 may be performed in various manners. Examples are shown in FIGS. 6A and 6B. In FIG. 6A, the conversion to feature vectors is performed by machine learning as a step 25A. Machine learning relates to techniques like numeral networks, where training data is provided in the form of examples how the design is converted to the feature vectors, and based on this training data, the system like in neural network is trained to perform the conversion. In FIG. 6B, in a step 25B conventional image analysis is used instead. It should be noted that also for steps 20 to 23, conventional image analysis, machine learning techniques or both may be used.

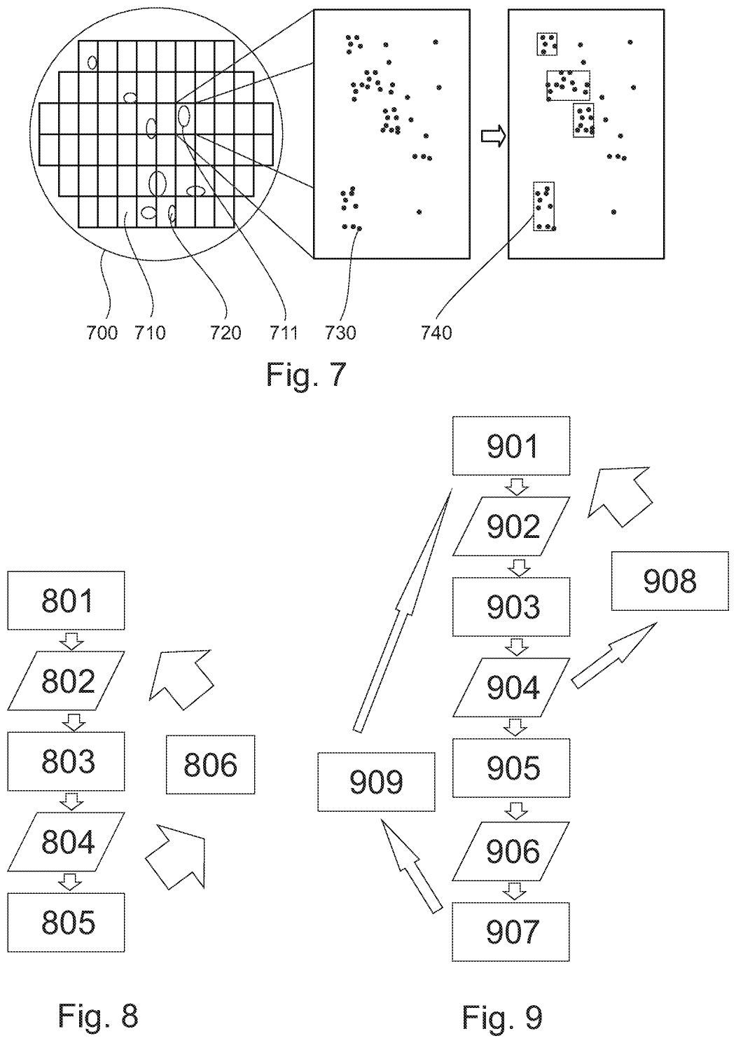

FIG. 7 shows an optical image of a processed wafer 700. Portions 710 of the processed wafer 700 may correspond to dies into which the wafer 700 is to be cut after all wafer processing steps have been performed. An analysis of the optical image of the processed wafer 700 may reveal several regions 720 which include possible defect candidates. For example, possible defect candidates may be identified using a method as described above.

In particular, possible defect candidates may be identified using a feature vector list. A possible defect candidate may indicate that with a certain probability a defect is present. As defects can have a very small size and/or the optical image may be affected by noise, an analysis of the optical image may allow for determining the presence of possible defect candidates but not be sufficient to actually determine whether there is a defect and/or what is the nature of the defect.

Heretofore, a region 711 of the optical image of the processed wafer 700 corresponding to a die with a very high density of possible defect candidates may be selected for further analysis.

Further analysis may include spectroscopic metrology, metrology using x-rays such as an x-ray transmission or diffraction microscope, or a device using charged particles such as a scanning electron microscope (SEM) or a focused ion beam (FIB)-microscope using electrons or other charged particles such as gallium or helium ions. These devices using charged particles are also collectively referred to as charged particle microscopes (CPM).

The image is formed based on secondary particles or radiation emitted from the wafer in response to the irradiation with the primary radiation, i.e. the charged particle beams. The secondary radiation may be in the form of secondary electrons or backscattered charged particles, or electromagnetic radiation such as light or x-rays. The composition, energy and angle of the secondary radiation can be controlled by the energy of the primary radiation and is an indication of the material composition and surface quality of the wafer surface scanned.

A recent development in the field of charged particle microscopes CPM is the MSEM, a multi-beam scanning electron microscope. In an MSEM, the wafer is irradiated by an array of electron beams, including for example 80 up to 10000 electron beams, as primary radiation. Each electron beam is typically separated by a distance of between 1 and 200 micrometers from its next neighboring electron beam. For example, the MSEM can have 100 separated electron beams, arranged on a hexagonal array, with the electron beams separated by a distance of 10 μm. These electron beams are scanned in parallel over an object, forming an image patch of for example 110 μm diameter. After acquisition of the image patch, a substrate or wafer stage is moved to a next patch position and the image of the next patch is obtained by again scanning of the electron beam array. Thereby, a high resolution images with below 5 nm resolution can be formed by stitching multiple image patches together. It is also possible to acquire high resolution images for specific locations on a wafer, for example for the above mentioned PCMs or critical areas only. With an MSEM, a fast scanning of a wafer surface is possible, and therefore, it is well suitable for wafer metrology with a high throughput and with high resolution of down to few nm, for example 5 nm. The throughput may depend on resolution and the number of beamlets. For 100 beamlets, typical examples of throughput are 3.5 sq mm/min (square-millimeter per minute), or up to 10 sq mm/min. With increasing number of beamlets, e.g. with 100×100 beamlets, the throughput can go up to more than 300 sq mm/min, or even more than 500 sq mm/min, or even exceed 1000 sq mm/min.

Within the region 711, further portions 740 with a high density of possible defect candidates may be selected for acquiring multi-beam scanning electron microscope images, for example. Marking areas which have an extremely high possible defect candidate density may allow for determining the physical origin of more defects and/or defect candidates, respectively, with a single multi-beam scanning electron microscope image.

Machine learning or other algorithms may be used to detect defect candidates and optionally classifying the defect candidates in the multi-beam scanning electron microscope image and/or the detected possible defect candidates based on the optical image. The machine learning algorithms, which may be based on neural networks or deep learning may have to be sufficiently trained to be able to detect defects and classify them.

In particular, methods described above with respect to the identification of defect candidates within optical images may be used.

FIG. 8 illustrates a method for training an algorithm for detecting defect candidates. In a first step 801, an optical image of a processed wafer is acquired and possible defect candidates are obtained as result 802. The number of possible defect candidates may be very high. For example, the number of possible defect candidates may amount to 12 million possible defect candidates. Applying a sub-sampling algorithm 803 results in a list of most probable defect candidates 804. The list of most probable defect candidates 804 may include fewer defect candidates than the number of possible defect candidates 802. For example, the list of most probable defect candidates 804 may include around 20 000 (twenty thousand) defect candidates. The list of most probable defect candidates 804 may than be further analyzed using single beam scanning electron microscopy 805. The result of the single beam scanning electron microscopy 805 may be used as training data for improving acquiring the optical image and detecting probable defect candidates 801 as well as for improving the sub-sampling algorithm 803.

FIG. 9 illustrates a further method for training a defect candidate detection algorithm. In a first step 901, an optical image of a processed wafer is acquired and possible defect candidates 902 identified. Afterwards, a multi-beam scanning electron microscopy image is acquired (step 903). Based on the multi-beam scanning electron microscopy image, noise within the optical image may be detected and actual defect candidates may be identified (step 904). The information 905 may be used for training the defect candidate detection algorithm (step 908).

Furthermore, the information on the noise may be used for filtering the optical image and identifying a portion 906 of the processed wafer with a high density of defect candidates (step 905).

The portion 906 of the processed wafer with a particularly high density of possible defect candidates or actual defect candidates may be further analyzed (step 907) using more elaborate techniques which are more suitable for detecting the physical origin of defects, in particular, of defects in the order of the CD. The techniques may include x-ray transmission or diffraction microscopy, single-beam scanning electron microscopy, x-ray techniques involving an x-ray transmission or diffraction microscope, a focused ion beam (FIB)-microscope using charged particles such as gallium or helium ions. An image obtained by this technique may be formed based on secondary particles or radiation emitted from the wafer in response to the irradiation with the primary radiation, i.e. the charged particle beams. The secondary radiation may be in the form of secondary electrons or backscattered charged particles, or electromagnetic radiation such as light or x-rays. The composition, energy and angle of the secondary radiation can be controlled by the energy of the primary radiation and is an indication of the material composition and surface quality of the wafer surface scanned. The result of the further analysis may be used to further train the defect candidate detection algorithm (step 909).

The combination of a training based on the MSEM image and a training based on a more thorough analysis of the defect candidates by, for example, single-beam scanning electron microscopy may significantly improve the candidate detection algorithm in a short period of time.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible program carrier for execution by, or to control the operation of, a processing device. Alternatively or in addition, the program instructions can be encoded on a propagated signal that is an artificially generated signal, e.g., a machine-generated electrical, optical, or electromagnetic signal that is generated to encode information for transmission to suitable receiver apparatus for execution by a processing device. A machine-readable medium can be a machine-readable storage device, a machine-readable storage substrate, a random or serial access memory device, or a combination of one or more of them.

The term “processing device” encompasses all kinds of apparatus, devices, and machines for processing information, including by way of example a programmable processor, a computer, or multiple processors or computers. The apparatus can include special purpose logic circuitry, e.g., an FPGA (field programmable gate array) or an ASIC (application specific integrated circuit) or RISC (reduced instruction set circuit). The apparatus can also include, in addition to hardware, code that creates an execution environment for the computer program in question, e.g., code that constitutes processor firmware, a protocol stack, an information base management system, an operating system, or a combination of one or more of them.

A computer program (which may also be referred to as a program, software, a software application, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or information (e.g., one or more scripts stored in a markup language document), in a single file dedicated to the program in question, or in multiple coordinated files (e.g., files that store one or more modules, sub programs, or portions of code).

A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input information and generating output. The processes and logic flows can also be performed by, and apparatus can also be implemented as, special purpose logic circuitry, e.g., an FPGA (field programmable gate array) or an ASIC (application specific integrated circuit) or RISC.

is Computers suitable for the execution of a computer program include, by way of example, general or special purpose microprocessors or both, or any other kind of central processing unit. Generally, a central processing unit will receive instructions and information from a read only memory or a random access memory or both. Elements of a computer include a central processing unit for performing or executing instructions and one or more memory devices for storing instructions and information. Generally, a computer will also include, or be operatively coupled to receive information from or transfer information to, or both, one or more mass storage devices for storing information, e.g., magnetic, magneto optical disks, or optical disks. However, a computer need not have such devices. Moreover, a computer can be embedded in another device, e.g., a mobile telephone, a smartphone or a tablet, a touchscreen device or surface, a personal digital assistant (PDA), a mobile audio or video player, a game console, a Global Positioning System (GPS) receiver, or a portable storage device (e.g., a universal serial bus (USB) flash drive), to name just a few.

Computer readable media (e.g., one or more machine readable hardware storage devices) suitable for storing computer program instructions and information include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and (Blue Ray) DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as an information server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital information communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In another example, the server can be in the cloud via cloud computing services.

While this specification contains many specific implementation details, these should not be construed as limitations on the scope of any of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations is and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

As can be seen from the above explanations, numerous variations and modifications are possible, and it is evident that the scope of the present application is not limited by the specific embodiments.

What is claimed is:

1. A method, comprising:
receiving a multi-beam scanning electron microscope (MSEM) image covering a portion of a processed wafer corresponding to a portion of an optical image of the processed wafer; and
training a defect candidate detection algorithm based on the optical image and a result of an analysis of the MSEM image with regard to defect candidates.

2. The method of claim 1, further comprising acquiring the optical image of a processed wafer.

3. The method according to claim 1, wherein training the defect candidate detection algorithm comprises:
identifying a possible defect candidate based on the optical image; and
verifying when the possible defect candidate is a defect candidate based on the MSEM image.

4. The method of claim 3, wherein the portion of the processed wafer corresponds to an area of the processed wafer comprising a higher density of possible defect candidates than other areas of the processed wafer.

5. The method of claim 4, wherein training comprises changing a parameter for acquiring the optical image.

6. The method of claim 5, wherein the parameter comprises at least one parameter selected from the group consisting of an illumination wavelength, an illumination polarity, illumination intensity, an image capturing time, and an imaging focus.

7. The method of claim 1, wherein training the defect candidate detection algorithm comprises detecting noise within the optical image.

8. The method of claim 1, wherein the portion of the processed wafer corresponds to a die to be cut from the processed wafer.

9. The method of claim 1, wherein training comprises changing a parameter for acquiring the optical image.

10. The method of claim 9, wherein the parameter comprises at least one parameter selected from the group consisting of an illumination wavelength, an illumination polarity, illumination intensity, an image capturing time, and an imaging focus.

11. The method of claim 1, further comprising:
obtaining a defect by analyzing the defect candidate based on a single-beam scanning electron microscope (SEM) image of the defect candidate; and
training the defect candidate detection algorithm with the optical image and the defect.

12. The method of claim 1, comprising:
using an optical camera configured to acquire the optical image of a processed wafer; and
using an evaluation device to apply the trained defect candidate detection algorithm on the optical image of the processed wafer to identify one or more defect candidates.

13. The method of claim 11, further comprising using a light source to illuminate the processed wafer.

14. The method of claim 1, further comprising applying the trained defect candidate detection algorithm on the optical image of the processed wafer to identify one or more defect candidates.

15. The method of claim 14, further comprising analyzing the one or more defects.

16. The method of claim 14, wherein applying the trained defect detection and classification algorithm on the MSEM image comprises classifying the defect.

17. One or more machine-readable hardware storage devices comprising instructions that are executable by one or more processing devices to perform operations comprising the method of claim 1.

18. A system comprising:
one or more processing devices; and
one or more machine-readable hardware storage devices comprising instructions that are executable by the one or more processing devices to perform operations comprising the method of claim 1.

19. The system of claim 18, further comprising:
an optical camera configured to acquire the optical image of a processed wafer; and
an evaluation device to apply the trained defect candidate detection algorithm on the optical image of the processed wafer to identify one or more defect candidates.

20. The system of claim 19, further comprising using a light source configured to illuminate the processed wafer.
